(19) United States
(12) Patent Application Publication
(10) Pub. No.: US 2006/0132855 A1
(43) Pub. Date: Jun. 22, 2006

(54) Image processing device

(75) Inventors: Kenji Dokuni, Kyoto-shi (JP); Katsushi Minanimo, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/280,773

(22) Filed: Nov. 16, 2005

(30) Foreign Application Priority Data
Dec. 22, 2004 (JP) 2004-371465
Mar. 17, 2005 (JP) 2005-077624

(51) Int. Cl. H04N 1/40

(52) U.S. Cl. 358/448

(57) ABSTRACT

An image processing device includes a document scanning unit, a color image processing unit, a monochrome image processing unit and a memory. A processing by the color image processing unit and a processing by the monochrome image processing unit are carried out simultaneously. The document scanning unit scans an original document. The color image processing unit converts scanned data obtained by the document scanning unit into color image data. The monochrome image processing unit converts the scanned data obtained by the document scanning unit into monochrome image data. The memory stores both the color image data and the monochrome image data.

### BACKGROUND OF THE INVENTION

1. Field of the Invention

The present invention relates to an image processing device. In particular, the present invention relates to an image processing device that creates color image data and monochrome image data by one scanning operation. The present invention also relates to a structure of data created by the image processing device.

2. Description of the Related Art

Recently, a digital Multi Function Peripheral (MFP) having a plurality of functions, such as a facsimile function, a printer function, a copy function and a scanner function, in one machine has become widespread.

An infrastructure, such as the Integrated Services Digital Network (ISDN), the Asymmetry Digital Subscriber Line (ADSL) and the Fiber To The Home (FTTH), has been developed. A continuous connection with a network, such as the Internet, can be maintained economically. Accordingly, an expectation is made on an even wider use of a network facsimile machine capable of transmitting and receiving facsimile data by using electronic mail.

Such a network facsimile machine includes a conventional Group 3 (G3) or Group 4 (G4) facsimile communication function. In addition, the network facsimile machine includes a function for transmitting and receiving facsimile data by using an internet protocol. When transmitting and receiving the facsimile data by using the internet protocol, for example, the network facsimile machine attaches the facsimile data to electronic mail and transmits and receives the electronic mail. For example, the electronic mail is communicated in accordance with the Simple Mail Transfer Protocol (SMTP) or the Post Office Protocol (POP).

As described above, the network facsimile machine transmits and receives data under various communication systems. Therefore, the network facsimile machine handles data differently according to a type of the communication system or a type of a destination terminal. For example, when carrying out G3 or G4 facsimile communication, even if an original document is color, there are cases where the network facsimile machine transmits the color original document as monochrome data to the destination terminal. Meanwhile, when attaching facsimile data to electronic mail and transmitting the electronic mail, if an original document is color, it is preferable for the network facsimile machine to transmit the facsimile data as color data to the destination terminal.

There are cases where the network facsimile machine simultaneously transmits facsimile data to a terminal capable of receiving only monochrome data and a terminal capable of receiving color data. In such cases, both color data and monochrome data become necessary.

A conventional facsimile server device capable of storing both monochrome image data and color image data stores at least one of the monochrome image data and the color image data. When a facsimile machine requests to retrieve image data from the facsimile server device, if the facsimile server device does not store the requested image data, the facsimile server device converts the stored image data to generate the requested image data. For example, when the facsimile server device stores only the color image data and receives a request of monochrome image data, a determination is made that the facsimile server device does not store the requested image data.

In an image processing system, which carries out a processing of color image data and monochrome image data, both the color image data and the monochrome image data become necessary according to an output form. Therefore, in such an image processing system, color image data is associated with monochrome image data corresponding to such color image data, and an integral management is carried out.

According to such a conventional art, to support both an output of a color image and an output of a monochrome image, the color image data and the monochrome image data are managed in separate files, and corresponding image data is associated with one another. When outputting a monochrome image, in case of an absence of monochrome image data and a presence of only color image data, monochrome image data is obtained by converting the color image data into the monochrome image data.

However, when using the above-described facsimile server device, to obtain monochrome image data, it is necessary to execute a processing for obtaining only monochrome image data from the beginning or a processing for obtaining monochrome image data by converting color image data into the monochrome image data.

When the processing for obtaining the monochrome image data from the beginning is executed, if color image data is requested later, it is impossible to obtain full-color image data from the monochrome image data.

Meanwhile, when obtaining monochrome binary compressed data from color multilevel compressed data, for example, a Joint Photographic Experts Group (JPEG) file is decoded to obtain multilevel color data (YCC). Then, a binarization process is executed on a Y component of the multilevel color data, and an encoding process of binary data is carried out according to a transmission method. For example, the binary data is converted into a Modified Modified READ (MMR) format, which is a compressing and encoding method for G3 or G4 facsimile.

When storing color image data in a memory and generating monochrome image data later, a JPEG file of the color image data is necessary to be decoded, binarized and converted into a MMR format. Therefore, a device is required to be provided with a plurality of processing circuits (Large Scale Integration (LSI)) and memories or the like. As a result, a hardware structure of the network facsimile machine becomes complicated. To prevent the hardware structure from being complicated, a bus is occupied by data communication between the processing circuits and the memory. As a result, a usage of the bus for another image processing is restricted, and an efficiency of the usage of the hardware is low.

A known digital MFP includes a facsimile function, a print function and a copy function or the like. Recently, there exists a demand for a dual processing from an aspect of reducing a processing time. Further, the dual processing is a processing in which a facsimile transmission process of scanned image data and a printing process of stored image data are carried out simultaneously, or a processing in which a facsimile transmission process of stored image data and a printing process of scanned image data are carried out simultaneously.

FIG. 8 illustrates a structure of a general digital MFP used in a conventional image processing system. In the digital MFP, color image data is input from a first input unit 202, such as a scanner for scanning a color original document. Then, a first encoder 204 executes a compressing process of the input color image data. Accordingly, compressed color image data is obtained. The compressed color image data is stored into a storage device 210. The digital MFP also includes a second input unit 206, which is an input unit different from the first input unit 202. A second encoder 208 executes a compressing process on color image data input from the second input unit 206. Accordingly, compressed color image data is obtained. The compressed color image data is stored into the storage device 210.

When carrying out a facsimile transmission process, which is a first mode of a monochrome output process based on the compressed color image data, an output image processing unit 212 is required to carry out a decompression process, a monochrome conversion process, a binarization process and a compressing process of the compressed color image data by a first monochrome conversion unit 214. In the same manner, when carrying out a printing process, which is a second mode of the monochrome output process, the output image processing unit 212 is required to carry out a decompression process, a monochrome conversion process and a binarization process of the compressed color image data by a second monochrome conversion unit 216.

When carrying out a dual processing in which the two monochrome output processes are carried out simultaneously, for each of the printing process and the facsimile transmission process, the decompression process, the monochrome conversion process, the binarization process, and according to necessity, the compression process are required to be carried out for obtaining compressed monochrome image data or monochrome image data from the compressed color image data when outputting data. Therefore, as illustrated in FIG. 8, the conventional digital MFP is required to include two monochrome conversion units 214 and 216.

Such a structure is not preferable from aspects of a load imposed on data processing and costs of the digital MFP. At a stage when a schedule of a future data processing is unclear, when color image data is input, monochrome image data is generated from the input color image data, and both the color image data and the monochrome image data corresponding to the color image data are stored. However, in such a case, a processing for managing a relationship between the color image data and the monochrome image data becomes complicated.

### SUMMARY OF THE INVENTION

In order to overcome the problems described above, a first advantage of the present invention is to provide an image processing device capable of carrying out an image processing without complicating a hardware structure or reducing an efficiency of a usage of the hardware, even when either monochrome image data or color image data is requested.

A second advantage of the present invention is to provide an image processing device, which can simultaneously carry out processes for outputting at least two types of image data by a simple structure, without complicating a management of the image data, and to provide a data structure of image data created by the image processing device.

To accomplish the first advantage of the present invention, according to an aspect of the present invention, an image processing device includes a document scanning unit, a color image processing unit, a monochrome image processing unit and a memory. The document scanning unit scans an original document. The color image processing unit converts scanned data obtained by the document scanning unit into color image data. The monochrome image processing unit converts the scanned data obtained by the document scanning unit into monochrome image data. The memory stores both the color image data and the monochrome image data. A process of the color image processing unit and a process of the monochrome image processing unit are carried out simultaneously.

According to another aspect of the present invention, in the image processing device, the document scanning unit may output data of a Red, Green, Blue (RGB) color space as the scanned data. The monochrome image processing unit may extract data of a G component from the RGB color space and create monochrome image data by using the data of the G component. Alternatively, the document scanning unit may output data of an RGB color space as the scanned data. The color image processing unit may convert the data of the RGB color space into data of a luminance or a lightness component and data of a color difference or a chromaticity component. The monochrome image processing unit may generate monochrome image data by using the data of the luminance or the lightness component.

According to another aspect of the present invention, in the image processing device, the color image processing unit may reduce a resolution of the color image data or the monochrome image data, which has been obtained by the color image processing unit, and generate low resolution image data. When the low resolution image data is generated, the generated low resolution image data may be associated with corresponding color image data or monochrome image data, and the low resolution image data may be stored in the memory.

According to another aspect of the present invention, the image processing device may also include a transmission unit, a transmission method table, a transmission destination accepting unit and a transmission image retrieving unit. The transmission unit transmits the color image data or the monochrome image data stored in the memory to a remote device. The transmission method table stores the remote device of a transmission destination and a transmission method for the transmission destination by associating one with the other. The transmission destination accepting unit accepts a designation of the remote device of the transmission destination. The transmission image retrieving unit refers to the transmission method table and determines the transmission method for the transmission destination accepted by the transmission destination accepting unit. The transmission image retrieving unit retrieves either the color image data or the monochrome image data compatible with the determined transmission method from the memory, and transmits the retrieved image data to the transmission unit.

According to another aspect of the present invention, the image processing device may include an image forming unit that carries out an image forming process of at least one of the color image data and the monochrome image data stored in the memory.

According to another aspect of the present invention, the image processing device may also include an output form accepting unit and a processing image data retrieving unit. The output form accepting unit accepts a designation of an output form of the color image data or the monochrome image data stored in the memory. The processing image data retrieving unit retrieves from the memory, either the color image data or the monochrome image data corresponding to the output form accepted by the output form accepting unit.

According to the above-described aspects of the present invention, color image data and monochrome image data can be created simultaneously by one document scanning operation. Therefore, even when either the monochrome image data or the color image data is requested, a processing time for such request can be shortened. An efficiency of a usage of hardware is satisfactory, and a load imposed on the hardware can be minimized.

To accomplish the second advantage of the present invention, according to an aspect of the present invention, an image processing device includes a first input unit, a color data compressing unit, a monochrome conversion unit, a monochrome data compressing unit, a coupling unit, a first storage unit, a second storage unit, an extracting unit, a first monochrome output unit, a second monochrome output unit and a control unit. The first input unit inputs color multilevel image data. The color data compressing unit executes a compressing process of the color multilevel image data input from the first input unit and generates compressed color image data. The monochrome conversion unit converts the color multilevel image data input from the first input unit into monochrome image data. The monochrome data compressing unit executes a compressing process of the monochrome image data generated by the monochrome conversion unit and generates compressed monochrome image data. The coupling unit couples the compressed color image data and the compressed monochrome image data generated from the same color multilevel image data and generates coupled image data. The first storage unit stores the coupled image data generated by the coupling unit. The second storage unit temporarily stores the monochrome image data generated by the monochrome conversion unit. The extracting unit extracts the compressed monochrome image data from the coupled image data retrieved from the first storage unit. The first monochrome output unit outputs the compressed monochrome image data or the monochrome image data. The second monochrome output unit outputs the compressed monochrome image data or the monochrome image data. The control unit controls to carry out a first processing and a second processing simultaneously. In the first processing, for the coupled image data previously stored in the first storage unit, the monochrome image data extracted by the extracting unit is output from the first monochrome output unit. In the second processing, the monochrome image data generated from the color multilevel image data input from the first input unit is output from the second monochrome output unit.

According to another aspect of the present invention, the image processing unit includes a multilevel decompression unit, a monochrome conversion unit, a monochrome data compressing unit and a coupling unit. The multilevel decompression unit executes a decompression process of compressed color image data input from a remote device. The monochrome conversion unit converts the color multilevel image data obtained by the multilevel decompression unit into monochrome image data. The monochrome data compressing unit executes a compressing process of the monochrome image data generated by the monochrome conversion unit and generates compressed monochrome image data. The coupling unit couples the compressed color image data and the compressed monochrome image data generated from the same color multilevel image data and generates coupled image data.

According to another aspect of the present invention, the monochrome conversion unit may include a monochrome conversion processing unit and a binarization unit. The monochrome data compressing unit may execute a compressing process of the monochrome image data, which is binary data, and generate compressed monochrome image data. The monochrome conversion processing unit generates monochrome multilevel image data from the color multilevel image data. The binarization unit binarizes the generated monochrome multilevel image data and generates monochrome image data.

According to another aspect of the present invention, the coupling unit may couple the compressed color image data and the compressed monochrome image data or the monochrome image data in the same file and generate coupled image data.

According to another aspect of the present invention, the coupled image data may include a header area and an image data area. The compressed color image data may be stored in the image data area. The compressed monochrome image data may be stored in the header area. A monochrome image data definition area may be provided in the header area of the coupled image data. Further, the monochrome image data definition area stores a tag indicating a storage location and a size of the stored compressed monochrome image data. The extracting unit may extract the compressed monochrome image data in accordance with the tag stored in the monochrome image data definition area.

According to another aspect of the present invention, the coupled image data may have a JPEG compressed data format structure including a Start Of Image (SOI) area, a monochrome storage area, a color storage area and an End Of Image (EOI) area. The SOI area stores starting information indicating a start of an image. The monochrome storage area stores the compressed monochrome image data. The color storage area stores the compressed color image data. The EOI area stores ending information indicating an end of an image.

According to an aspect of the present invention, a data structure has a JPEG compressed data format structure generated from color multilevel image data input to an image processing device. The data structure includes an SOI area, an application segment area, a compressed image data storage area and an EOI area. The SOI area stores starting information indicating a start of an image. In the application segment area, an application segment is inserted. The compressed image data storage area stores compressed image data. The EOI area stores ending information indicating an end of the image. The compressed image data storage area stores compressed color image data generated from the color multilevel image data. The application segment area stores compressed monochrome image data generated from the color multilevel image data.

In the above-described data structure, the compressed monochrome image data is generated by compressing monochrome binary image data.

In the above-described data structure, the application segment area may include a monochrome image data definition area. Further, the monochrome image data definition area stores a tag indicating a storage location and a size of the stored compressed monochrome image data.

According to the present invention, an image processing can be carried out without complicating a hardware structure or without reducing an efficiency of a usage of the hardware even when either the monochrome image data or the color image data is requested.

According to the present invention, processes for outputting at least two types of image data can be carried out simultaneously by a simple structure, without complicating a management of the image data.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a control configuration of a digital MFP according to a preferred embodiment of the present invention.

FIG. 2 is a block diagram illustrating a first example of an image processing unit according to a preferred embodiment of the present invention.

FIG. 3 is a block diagram illustrating a second example of an image processing unit according to a preferred embodiment of the present invention.

FIG. 4 is a block diagram illustrating an image processing device according to a preferred embodiment of the present invention.

FIG. 5 is a block diagram illustrating an option unit for when compressed color image data is input from a remote device according to a preferred embodiment of the present invention.

FIG. 6 illustrates a structure of image data according to a preferred embodiment of the present invention.

FIG. 7 is a view schematically illustrating a data processing of data output from the image processing device.

FIG. 8 illustrates a conventional structure of a general digital MFP.

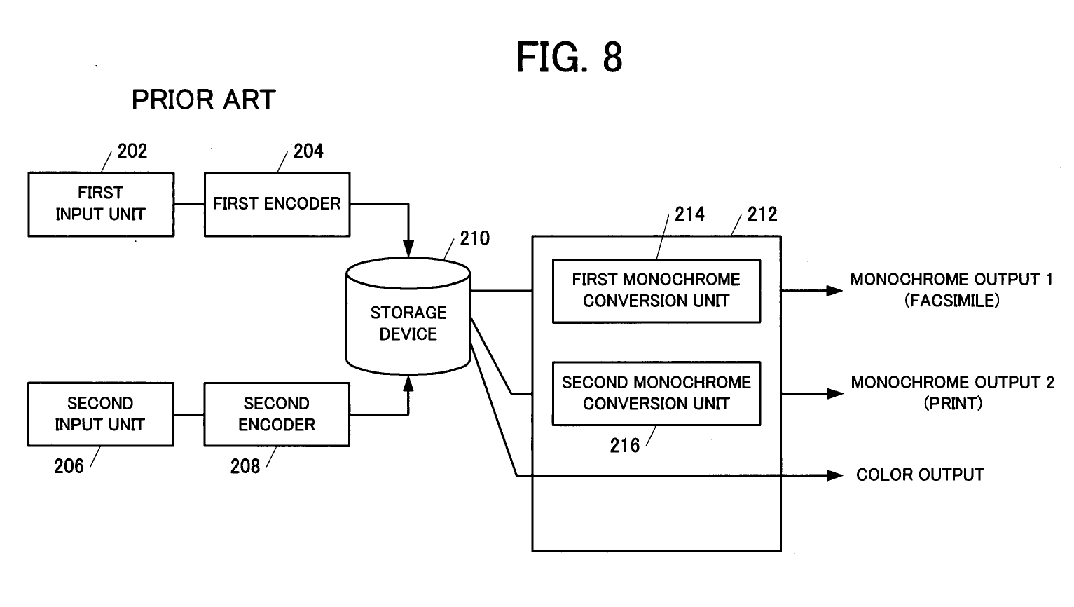

### DETAILED DESCRIPTION OF PREFERRED EMBODIMENTS

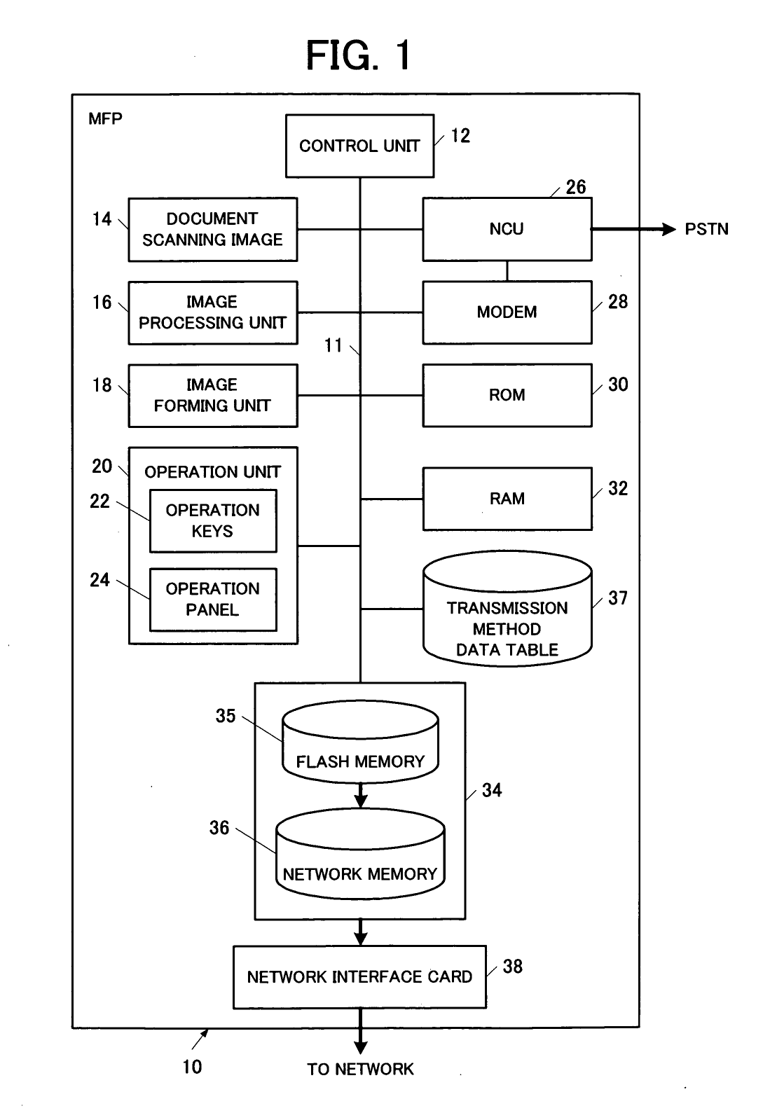

(First Preferred Embodiment) With reference to the drawings, a description will be made of a digital MFP including an image processing device according to a first preferred embodiment of the present invention. FIG. 1 is a block diagram schematically illustrating a configuration of a digital MFP 10 according to the first preferred embodiment of the present invention.

A control unit 12 is connected to each component of the digital MFP 10 via a bus 11. The control unit 12 controls each component of the digital MFP 10 by a control program stored in a Read Only Memory (ROM) 30 in accordance with an input operation performed from an operation unit 20, for example. A Random Access Memory (RAM) 32 temporarily stores various pieces of information relating to a control state of the digital MFP 10, for example. The RAM 32 provides a working area of the control unit 12.

The operation unit 20 includes various operation keys 22 for operating the digital MFP 10. An input operation performed from each of the operation keys 22 is transmitted to the control unit 12, and the control unit 12 controls the digital MFP 10 in accordance with the input operation.

The operation unit 20 includes an operation panel 24, which also functions as a display unit. The operation panel 24 includes a display having a touch screen function. The display displays an operational state of the digital MFP 10. The display also displays a display for accepting a designation of a transmission destination. In some cases, the display displays a display for accepting a designation of image data. When the operation unit 20 functions as an output form accepting unit, the display displays a display for accepting a designation of an output form of image data. For example, the output form of the image data is an image forming process, transmission of the image data to a remote terminal device, and facsimile communication. The control unit 12 retrieves panel image data from the ROM 30, and displays the retrieved panel image data on the operation panel 24. The panel image data stored in the ROM 30 is data to be displayed on the operation panel 24. When an input operation is performed from each of the operation keys 22 displayed on the operation panel 24, the input operation is transmitted to the control unit 12. Then, the control unit 12 controls the digital MFP 10 in accordance with the input operation.

A document scanning unit 14 includes an automatic document transportation device that enables a plurality of original documents to be scanned continuously according to necessity. The document scanning unit 14 optically scans an original document of a photograph, a document, a drawing or the like. The document scanning unit 14 measures strength of a reflected light and a transmitted light and carries out an Analog-to-Digital (AD) conversion of a measurement result. Then, the document scanning unit 14 outputs scanned data (multilevel non-compressed data: RGB). The scanned data obtained by the document scanning unit 14 is transmitted to an image processing unit 16 via the bus 11 and converted into color image data and monochrome image data. Then, the color image data and the monochrome image data are stored into a memory 34.

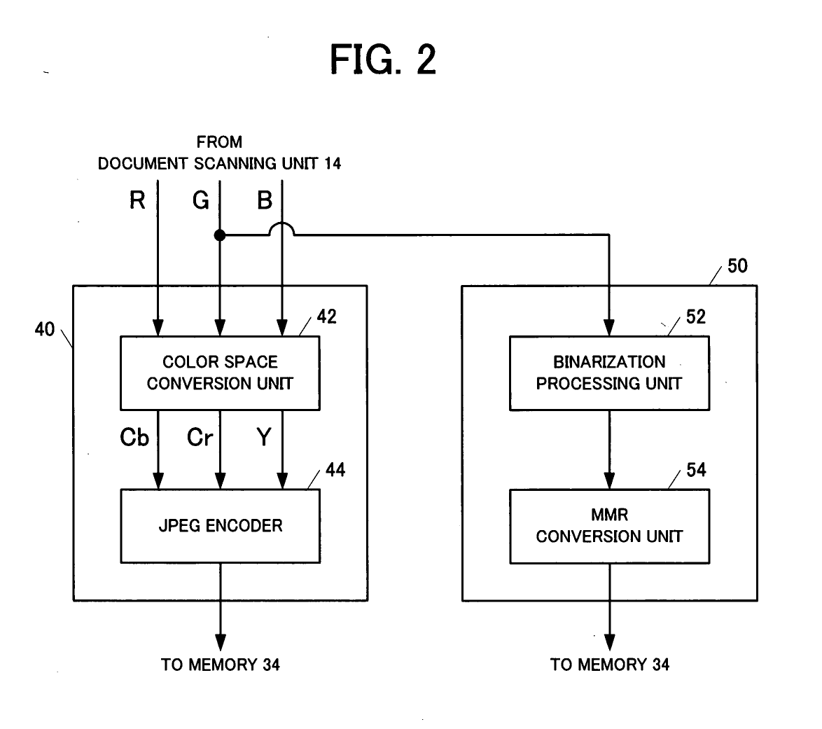

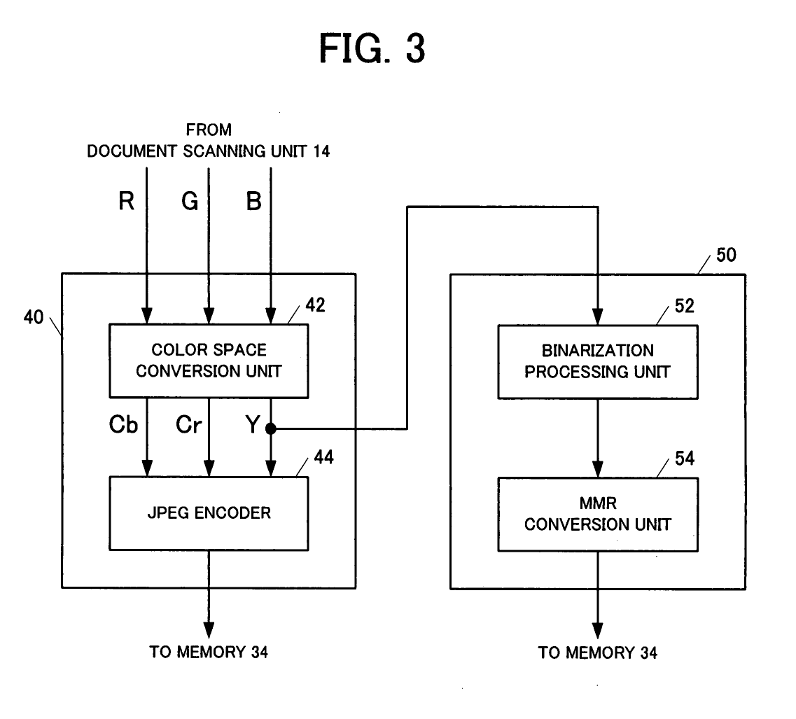

FIG. 2 and FIG. 3 are block diagrams illustrating a configuration of the image processing unit 16.

As illustrated in FIG. 2 and FIG. 3, the image processing unit 16 includes a color image processing unit 40 and a monochrome image processing unit 50. The color image processing unit 40 converts the scanned data transmitted from the document scanning unit 14 via the bus 11 into color image data (color multilevel compressed data). The monochrome image processing unit 50 converts the scanned data transmitted from the document scanning unit 14 via the bus 11 into monochrome image data (monochrome binary compressed data). The control unit 12 controls so that a processing by the color image processing unit 40 and a processing by the monochrome image processing unit 50 are carried out simultaneously.

In FIG. 2, the color image processing unit 40 includes a color space conversion unit 42 and a JPEG encoder 44. The color space conversion unit 42 converts a color space of the scanned data from an RGB color space into a YCrCb color space. The YCrCb color space is a color space including a luminance component (Y component) and a color difference component (CrCb component). The JPEG encoder 44 encodes the data after the color space conversion (color multilevel non-compressed data of the YCrCb color space) into a JPEG format (color multilevel compressed data).

Meanwhile, the monochrome image processing unit 50 includes a binarization processing unit 52 and an MMR conversion unit 54. The binarization processing unit 52 executes a process for reducing a level of tone (for example, a binarization process) on G component data of the scanned data (RGB), and generates binary data (monochrome binary non-compressed data). That is, the binarization processing unit 52 converts the scanned data into the binary data. The MMR conversion unit 54 encodes the binarized data (monochrome binary non-compressed data) into an MMR format (monochrome binary compressed data). Further, the process for reducing the level of the tone is not limited to the binarization process and can be a four-leveling process.

According to FIG. 2, the color image processing unit 40 generates color image data of a JPEG format from the scanned data (RGB). The monochrome image processing unit 50 retrieves a G signal of the scanned data as monochrome multilevel data, and generates monochrome image data of an MMR format in accordance with the G signal. The processing for generating the color image data by the color image processing unit 40 and the processing for generating the monochrome image data by the monochrome image processing unit 50 are carried out at the same time. That is, in parallel with the color space conversion process by the color space conversion unit 42 and/or the encoding process by the JPEG encoder 44, the binarization process by the binarization processing unit 52 and/or the encoding process by the MMR conversion unit 54 are carried out. The color image data generated by the color image processing unit 40 and the monochrome image data generated by the monochrome image processing unit 50 are transmitted to the memory 34 via the bus

In the example illustrated in FIG. 2, the monochrome multilevel non-compressed data is generated by retrieving a G signal of the scanned data. In the example illustrated in FIG. 3, monochrome multilevel non-compressed data is generated by retrieving a luminance signal after a color space conversion process is executed by the color space conversion unit 42. That is, in the example illustrated in FIG. 2, the binarization processing unit 52 carries out the binarization process on the G signal of the scanned data from the document scanning unit 14. In the example illustrated in FIG. 3, the binarization processing unit 52 carries out a binarization process on the luminance signal (Y signal) from the color space conversion unit 42. The structure other than the binarization processing unit 52 is the same in FIG. 2 and FIG. 3.

In the example illustrated in FIG. 3, the color image processing unit 40 generates JPEG format color image data from the scanned data (RGB). The monochrome image processing unit 50 retrieves the Y signal from the color image processing unit 40 as monochrome multilevel non-compressed data. In accordance with the Y signal, the monochrome image processing unit 50 generates MMR format monochrome image data. The process for generating the color image data by the color image processing unit 40 and the process for generating the monochrome image data by the monochrome image processing unit 50 are carried out simultaneously. That is, in parallel with the color space conversion process by the color space conversion unit 42 and/or the encoding process by the JPEG encoder 44, the binarization process by the binarization processing unit 52 and/or the encoding process by the MMR conversion unit 54 are carried out. The color image data generated by the color image processing unit 40 and the monochrome image data generated by the monochrome image processing unit 50 are transmitted to the memory 34 via the bus 11.

Further, the color space of the output data output from the color space conversion unit 42 of the color image processing unit 40 is not limited to the YCrCb color space and may be a Lab color space. That is, the color space conversion unit 42 may convert the data of the RGB color space into the data of Lab color space data. The Lab color space is a color space including a lightness component (L component) and a chromaticity component (ab component) When converting the color space into the Lab color space, the binarization processing unit 52 of the monochrome image processing unit 50 can retrieve an L signal, which is a signal of the lightness component, and carry out a binarization process.

The image processing unit 16 can separately create low resolution image data by reducing a resolution of the color image data or the monochrome image data obtained from each of the color image processing unit 40 and the monochrome image processing unit 50. When the low resolution image data is generated, the low resolution image data can be associated with the corresponding color image data or the corresponding monochrome image data and the low resolution image data can be stored in the memory 34.

As described above, by storing the low resolution image data by associating with the corresponding color image data or the corresponding monochrome image data, when accepting a designation of image data, the low resolution image data can be displayed. That is, when an output form accepting unit described hereinafter accepts a designation of output image data from the image data stored in the memory 34, the low resolution image data can be displayed on a display device of the output form accepting unit. Accordingly, an operationality of a user when designating an image improves. In this case, the control unit 12 operates as an image data retrieving unit. When the output form accepting unit accepts a designation of an image by a method for designating a low resolution image, the control unit 12 as the image data retrieving unit retrieves color image data or monochrome image data corresponding to the designated image from the memory 34.

In the first preferred embodiment of the present invention, a remote terminal device connected via a network may be operated as the output form accepting unit. In this case, as described above, when designating an output image, according to necessity, the remote terminal device displays a display for accepting a designation of an output form of image data. For example, when accepting the destination of the output form, a selection button for selecting the output form is displayed. The output form includes an image forming process, transmission to the remote terminal device and facsimile communication. A content of the designation accepted by the remote terminal device is transmitted to the control unit 12 via the network. The control unit 12 appropriately retrieves a processing program stored in the ROM 30, develops the processing program in the RAM 32 and executes the processing program. Accordingly, the control unit 12 controls to carry out the processing designated by the digital MFP 10. In this case, the control unit 12 operates as a processing image data retrieving unit. The control unit 12 selects and retrieves from the image data stored in the memory 34, either the color image data or the monochrome image data as optimum image data determined according to the designated output form. Then, when the user designates the image data and the output form, one of or both of the color image data and the monochrome image data are automatically selected and retrieved by an operation of the control unit 12. Further, the operation unit 20 may be operated as the output form accepting unit.

An output form can be designated when performing an operation relating to a scanning process of an original document. The operation relating to the scanning process of the original document can be performed from the operation unit 20, for example. In this case, when scanning the original document, instead of creating both of the color image data and the monochrome image data and storing both image data in the memory 34, only one of image data determined by the designated output form may be stored into the memory 34. Moreover, only one of the image data determined by the output form designated at the scanning process of the original document may be created.

Referring to FIG. 1 again, when the user operates the output form accepting unit and designates an image forming process, the image forming unit 18 carries out an image forming process based on prescribed image data. Optimum image data may be either the color image data or the monochrome image data and may be designated arbitrarily by the user. Alternatively, either the color image data or the monochrome image data may be set as default image data, and the setting may be changed by an operation performed by the user according to necessity.

A Network Control Unit (NCU) 26 and a Modular-Demodulator (MODEM) 28 operate as a transmission unit. The NCU 26 carries out an operation for making and breaking a Public Switched Telephone Network (PSTN). The NCU 26 includes a function for transmitting a dial pulse according to a facsimile number of a destination, and a function for detecting an incoming call. The NCU 26 connects the MODEM 28 and the PSTN according to necessity.

The MODEM 28 functions as a facsimile modem capable of carrying out normal facsimile communication. That is, the MODEM 28 modulates transmission data and demodulates received data. Specifically, the MODEM 28 modulates the transmission data into an audio frequency signal and transmits the audio frequency signal via the NCU 26 to the PSTN. The MODEM 28 demodulates the audio frequency signal received from the destination via the PSTN and the NCU 26 into a digital signal.

In the normal facsimile communication, only a small number of facsimile machines can receive color image data. Therefore, when facsimile communication is selected as the output form, monochrome image data can be selected as optimum image data. When a transmission destination is a facsimile machine capable of receiving color image data, color image data can be selected as optimum image data.

When transmitting image data to a remote terminal device through the Internet by using an Internet protocol, a network interface card 38 (transmission unit) establishes a connection with the network. In this case, since a terminal device at a receiving end generally supports color image data, color image data is selected as the optimum image data determined according to the output form.

In this case, the memory 34 may include a flash memory 35 and a network memory 36. The flash memory 35 temporarily stores image data. The network memory 36 stores image data for a prescribed period of time (a long period of time). The color image data and the monochrome image data generated by the image processing unit 16 may be stored once in the flash memory 35. Then, according to necessity, the color image data and the monochrome image data may be transferred to the network memory 36. The color image data and the monochrome image data transferred to the network memory 36 may be deleted from the flash memory 35.

As described above, when the memory 34 includes the flash memory 35 and the network memory 36, the network memory 36 is preferably a high-capacity hard disk. The flash memory 35 and the network memory 36 may be arranged on the same substrate, or may be provided on separate substrates and connected to one another via an interface.

The digital MFP 10 includes a transmission method data table 37 (transmission method table) that stores a remote device to be a transmission destination and a transmission method for each transmission destination by associating one with the other. For example, the transmission method is either facsimile communication or transmission of image data by the Internet protocol. When the operation unit 20 operates as a transmission destination accepting unit, which designates a transmission destination, and the user enters a transmission destination, the control unit 12 operates as a transmission image retrieving unit. The control unit 12 refers to the transmission method data table 37, and determines the transmission method in accordance with the accepted transmission destination. Then, the control unit 12 retrieves image data that is most appropriate to the determined transmission method. That is, the control unit 12 (transmission image retrieving unit) retrieves from the memory 34, either the color image data or the monochrome image data as the optimum image data for the determined transmission method.

For example, when the designated transmission destination is a destination registered to carry out facsimile communication, the control unit 12 retrieves monochrome image data and executes a facsimile communication process by using the MODEM 28. When the designated transmission destination is a destination registered to transmit image data by using the Internet protocol, the control unit 12 retrieves color image data and executes a transmission process through the network by the network interface card 38.

As described above, according to the first preferred embodiment of the present invention, color image data and monochrome image data can be created simultaneously by one document scanning operation. Therefore, even when either the monochrome image data or the color image data is requested, a processing time for such request can be shortened. An efficiency of a usage of the hardware is satisfactory, and a load imposed on the hardware can be minimized.

Further, the above-described preferred embodiment may be modified in numerous ways without departing from the spirit and the scope of the present invention. For example, in the first preferred embodiment described above, the MMR format is used as the monochrome image data. However, the present invention shall not be limited to such an example. Other monochrome encoded data may be used as the monochrome image data. For example, the Modified Huffman (MH) compressing method, the Joint Bi-level Image experts Group (JBIG) or the Modified READ (MR) method may be used as a binary encoding method.

(Second Preferred Embodiment) With reference to the drawings, a description will be made of an image processing device and a data structure according to a second preferred embodiment of the present invention.

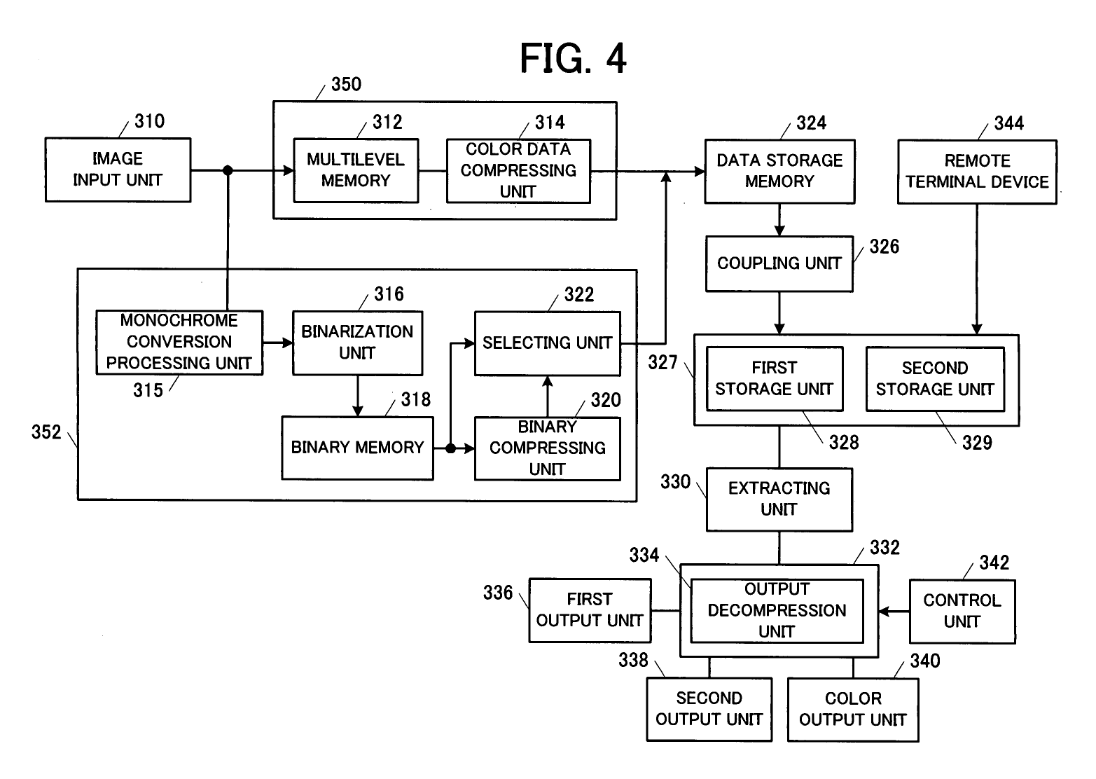

FIG. 4 is a block diagram illustrating an example of a configuration of the image processing device according to the second preferred embodiment of the present invention. The image processing device includes an image input unit 310, a color data compressing unit 314, a monochrome conversion processing unit 315, a binarization unit 316, a binary compressing unit 320, a coupling unit 326, a first storage unit 328, a second storage unit 329, an extracting unit 330, a first output unit 336, a second output unit 338 and a control unit 342. The image input unit 310 is a first input unit that inputs color multilevel image data. The color data compressing unit 314 executes a compressing process of the color multilevel image data input from the image input unit 310 and generates compressed color image data. The monochrome conversion processing unit 315 and the binarization unit 316 are a monochrome conversion unit that converts the color multilevel image data input from the image input unit 310 into monochrome image data. The binary compressing unit 320 is a monochrome data compressing unit that executes a compressing process of the monochrome image data generated by the monochrome conversion unit and generates compressed monochrome image data. The coupling unit 326 couples the compressed color image data and the compressed monochrome image data generated from the same color multilevel image data and generates coupled image data. The first storage unit 328 stores the coupled image data generated by the coupling unit 326. The second storage unit 329 temporarily stores the monochrome image data generated by the monochrome conversion unit. The extracting unit 330 extracts the compressed monochrome image data from the coupled image data retrieved from the first storage unit 328. The first output unit 336 is a first monochrome output unit that outputs the compressed monochrome image data or the monochrome image data. The second output unit 338 is a second monochrome output unit that outputs the compressed monochrome image data or the monochrome image data. The control unit 342 controls to simultaneously carry out a first processing and a second processing for the coupled image data stored previously in the first storage unit 328. In the first processing, the monochrome image data extracted by the extracting unit 330 is output from the first output unit 336. In the second processing, the monochrome image data generated from the color multilevel image data, which has been input from the image input unit 310, is output from the second output unit 338.

The image input unit 310 generates an image or loads an image, and transmits the image as color multilevel image data to a color data creating unit 350 and a monochrome data creating unit 352 described hereinafter. For example, the image input unit 310 is a scanning device including a scanner for scanning an original document, a computer system that loads an image, or a photographic device such as a digital camera.

Further, the present invention is not limited to an example in which the image input unit 310 outputs the color multilevel image data, which is non-compressed data, to the color data creating unit 350. The image input unit 310 may output the compressed color image data to the color data creating unit 350. In this case, a multilevel decompression unit may be arranged at an output end of the image input unit 310. The multilevel decompression unit decompresses the compressed color image data to convert the compressed color image data into color multilevel image data, and outputs the color multilevel image data to the color data creating unit 350 and the monochrome data creating unit 352. A data processing control unit may be arranged in the image input unit 310. Further, according to a form of the input data, the data processing control unit sorts the input data, whether to output to the multilevel decompression unit or to output to each of the color data creating unit 350 and the monochrome data creating unit 352. When compressed color image data is input, the data processing control unit outputs the compressed color image data to the multilevel decompression unit. When the color multilevel image data is input, the data processing control unit outputs the color multilevel image data to each of the color data creating unit 350 and the monochrome data creating unit 352.

The color data creating unit 350 includes a multilevel memory 312 and a color data compressing unit 314. The multilevel memory 312 stores color multilevel image data. The color data compressing unit 314 executes a compressing process to compress the data stored in the multilevel memory 312 into a compressed data format handled under the JPEG method, for example.

The color multilevel image data is stored once in the multilevel memory 312, and transmitted to the color data compressing unit 314 for each block to be executed with the compressing process. In the color data compressing unit 314, a discrete cosine transform is executed on the color multilevel image data, and the color multilevel image data is divided into fundamental frequency ranges. Information on divided coefficients is quantized, and a Huffman encoding process is executed by using a statistical feature of a quantization coefficient. Accordingly, the color multilevel image data is converted into compressed color image data. The compressed color image data obtained in the above-described manner is transmitted to the data storage memory 324.

The monochrome data creating unit 352 includes the monochrome conversion processing unit 315, the binarization unit 316, a binary memory 318, a binary compressing unit 320 and a selecting unit 322. The monochrome conversion processing unit 315 generates monochrome multilevel image data from the color multilevel image data. The binarization unit 316 executes a binarization process to binarize the generated monochrome multilevel image data to generate monochrome image data. The binary memory 318 stores the monochrome image data, which is monochrome binary image data obtained by the binarization unit 316. The binary compressing unit 320 executes a compressing process of the monochrome image data stored in the binary memory 318. The selecting unit 322 compares the compressed monochrome image data obtained by the binary compressing unit 320 with monochrome image data yet to be compressed, and selects data.

The monochrome conversion processing unit 315 executes a grayscale process of the color multilevel image data in accordance with data of luminance or lightness, for example, a Y signal of a YCC signal. As a result, the color multilevel image data is converted into monochrome multilevel image data. Then, the monochrome multilevel image data is transmitted to the binarization unit 316. The binarization unit 316 executes a binarization process of the monochrome multilevel image data, and the monochrome multilevel image data is converted into monochrome image data. The monochrome image data is stored once in the binary memory 318. The monochrome image data is transmitted to the binary compressing unit 320 for each block to be executed with the compressing process. The binary compressing unit 320 compresses the monochrome image data stored in the binary memory 318 by a prescribed compressing method, and the monochrome image data is converted into compressed monochrome image data. Further, the prescribed compressing method is a binary encoding method, such as the MMR, the MH, the JBIG or the MR method. The selecting unit 322 compares the monochrome image data stored in the binary memory 318 with the compressed monochrome image data obtained by the binary compressing unit 320, and selects data to be transmitted to the data storage memory 324. The selected data is transmitted to the coupling unit 326 as monochrome data. In this case, for example, data of a smaller size is selected, or data is selected according to a monochrome output form described hereinafter. For example, when carrying out a monochrome printing process, monochrome image data is selected. When carrying out a facsimile transmission process, compressed monochrome image data is selected. Further, the selecting unit 322 is optional. Without providing the selecting unit 322, the compressed monochrome image data obtained by the binary compressing unit 320 may be transmitted to the data storage memory 324 at all times.

The compressed color image data transmitted from the color data compressing unit 314 is associated with the data transmitted from the selecting unit 322, in other words, the compressed monochrome image data or the monochrome image data, and stored once in the data storage memory 324.

The coupling unit 326 couples the compressed color image data and the compressed monochrome image data or the monochrome image data, which are stored by being associated with one another in the data storage memory 324, within the same file and creates coupled image data.

The image data (compressed monochrome image data) input for facsimile transmission is not necessarily required to be coupled with the compressed color image data. The image data (monochrome image data) input for a printing process is not necessarily required to be coupled with the compressed color image data. Therefore, the image data input for the facsimile transmission or the image data input for the printing process may be transmitted directly to the second storage unit 329 of a storage device 327 described hereinafter, without being coupled with the compressed color image data by the coupling unit 326. In the above-described case, a process for creating the compressed color image data and a process for creating the coupled image data can be omitted, and a load imposed on the hardware can be reduced.

A description has been made of a case where the color multilevel image data obtained by the scanning device, such as the scanner, is input and processed. However, the present invention is not limited to the above-described example. For example, compressed color multilevel image data created and compressed by another computer system or a photographic device may be input, and compressed monochrome image data may be created.

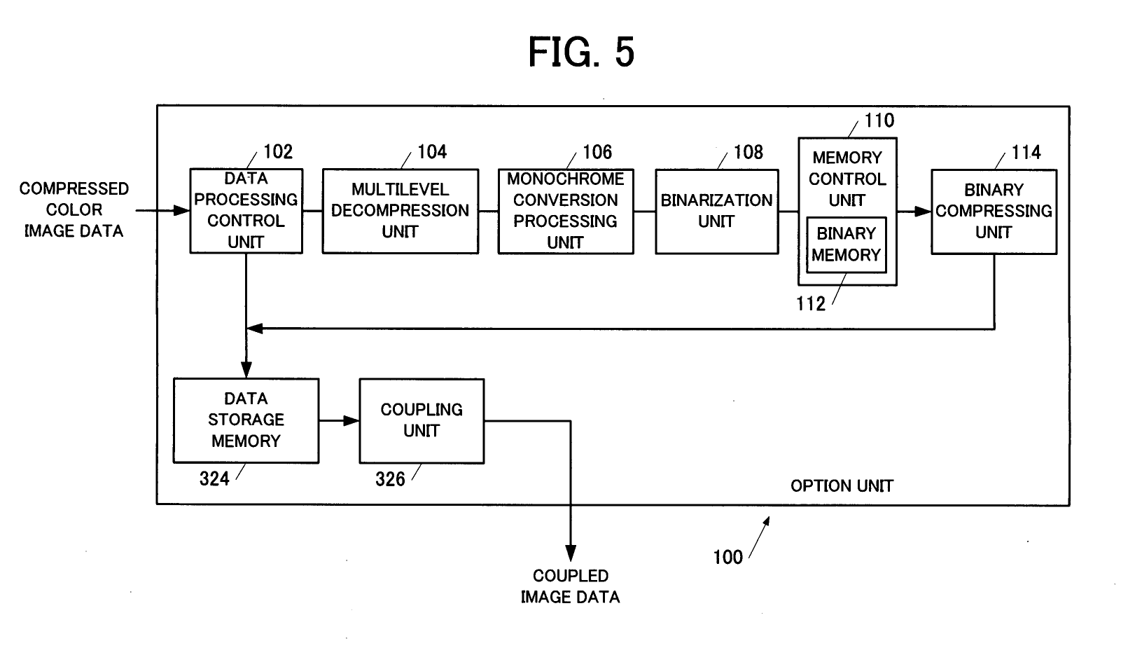

FIG. 5 illustrates an option unit 100 that can be applied to the image processing device according to the second preferred embodiment of the present invention and which can be arranged as an option for carrying out the above-described operation.

The option unit 100 includes a multilevel decompression unit 104, a monochrome conversion processing unit 106, a binarization unit 108, a binary compressing unit 114 and a coupling unit 326. The multilevel decompression unit 104 executes a decompression process of the compressed color image data input from a remote device. The monochrome conversion processing unit 106 and the binarization unit 108 function as a monochrome conversion unit that converts the color multilevel image data obtained by the multilevel decompression unit 104 into monochrome image data. The binary compressing unit 114 functions as a monochrome data compressing unit that executes a compressing process of the monochrome image data generated by the monochrome conversion unit and generates compressed monochrome image data. The coupling unit 326 couples the compressed color image data and the compressed monochrome image data generated from the same color multilevel image data, and generates coupled image data.

In FIG. 5, the compressed color image data generated by another computer system or the like is transmitted to the data processing control unit 102. When the compressed color image data is input to the data processing control unit 102, the data processing control unit 102 transmits the compressed color image data to the data storage memory 324 and also to the multilevel decompression unit 104.

The multilevel decompression unit 104 executes a decompression process of the compressed color image data, and converts the compressed color image data into color multilevel image data, for example, RGB data. Then, the multilevel decompression unit 104 transmits the color multilevel image data to the monochrome conversion processing unit 106. The monochrome conversion processing unit 106 executes a grayscale process or the like based on luminance data or lightness data of the color multilevel image data. As a result, the color multilevel image data is converted into monochrome multilevel image data. The monochrome multilevel image data is transmitted to the binarization unit 108. The binarization unit 108 executes a binarization process of the monochrome multilevel image data to obtain monochrome image data, which is binary data. The monochrome image data is stored temporarily in the binary memory 112 of a memory control unit 110. The memory control unit 110 transmits the monochrome image data stored in the binary memory 112 to the binary compressing unit 114 under a prescribed timing for each block. The binary compressing unit 114 compresses the monochrome image data by the above-described prescribed compressing method. As a result, the monochrome image data is converted into compressed monochrome image data. The binary compressing unit 114 transmits the compressed monochrome image data to the data storage memory 324. The binary compressing unit 114 may compare the monochrome image data and the compressed monochrome image data and select data to be transmitted to the data storage memory 324. As described above, even when the compressed color image data, which has been already executed with the compressing process, is input from a remote device, the image processing device can obtain compressed monochrome image data.

In the same manner as the example illustrated in FIG. 4, also in the option unit 100, the compressed color image data and the compressed monochrome image data may be associated with one another and loaded temporarily in the data storage memory 324. Then, the coupling unit 326 may couple the compressed color image data and the compressed monochrome image data in the same file. Accordingly, coupled image data may be obtained and output.

Next, a description will be made of the coupled image data. The coupled image data includes a header area and an image data area. The compressed color image data is stored in the image data area. The compressed monochrome image data is stored in the header area. The compressed monochrome data may be data formed by executing a monochrome conversion process, a binarization process and a compressing process on the color multilevel image data, as described above.

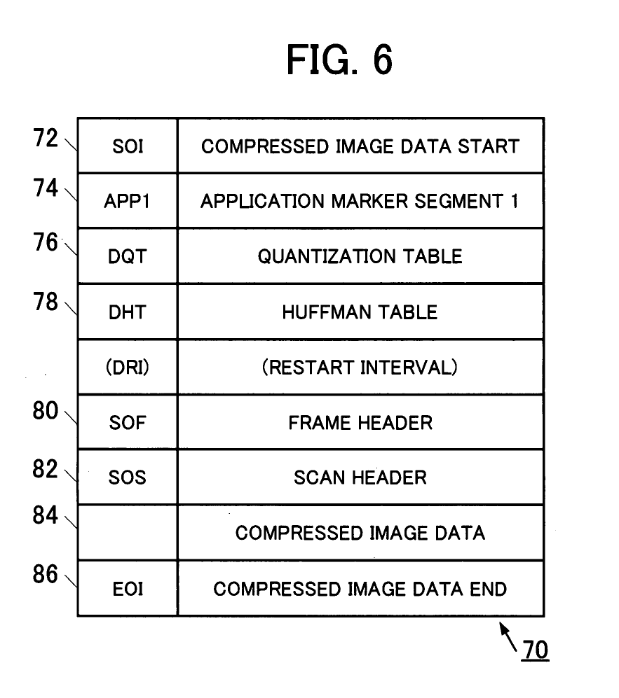

FIG. 6 illustrates a data structure of the coupled image data according to the second preferred embodiment of the present invention. The data structure is a structure of data including a structure of a JPEG compressed data format. Specifically, the data structure includes an SOI area 72, an application marker segment 1 (APP1) area 74, a Define Quantization Table (DQT) area 76, a Define Huffman Table (DHT) area 78, a restart interval area according to necessity, a Start Of Frame (SOF) area 80, a header area including a Start Of Scan (SOS) area 82, an image data area including a compressed image data storage area 84, and an EOI area 86 in this order from an upstream side of data stream 70.

The SOI area 72 is an area that stores starting information indicating a start of an image in the data stream 70. The APP1 area 74 is an area for embedding data in a JPEG file. The APP1 area 74 is a part where information necessary for a high-order application of the JPEG is inserted. As to be described later, the information necessary for the high-order application of the JPEG is specifically compressed monochrome image data or monochrome image data. Further, when the JPEG image data is handled by a device not supporting such an application, the APP1 area 74 is ignored.

The DQT area 76 stores a table created when a quantization process of the color multilevel image data is carried out by the color data compressing unit 314. The DHT area 78 stores a table used in a Huffman encoding process carried out by the color data compressing unit 314.

The SOF area 80 is an area for setting an image size of the color multilevel image data (for example, a number of pixels in a horizontal direction and a vertical direction), a sampling ratio of each color signal (Y, Cb, Cr) per unit of a processing in the quantization process, and a quantization table number or the like. The SOS area 82 is an area defining which Huffman table is to be assigned to each component.

The compressed image data storage area 84 is a part where the compressed color image data is inserted and stored. The EOI area 86 is an area for storing ending information indicating an end of the image in the data stream 70.

The APP1 area 74 includes an area for storing the compressed monochrome image data. The APP1 area 74 also includes a monochrome image data definition area that stores attribute information of the compressed monochrome image data. That is, the APP1 area 74 stores the compressed monochrome image data and the attribute information of the compressed monochrome image data. For example, the attribute information includes a data size and a storage location. The storage location is an address in the data stream 70. The monochrome image data definition area stores a tag indicating the data size and the storage location (address).

As described above, both the compressed monochrome image data and the compressed color image data can be inserted in one JPEG file. Conventionally, the compressed monochrome image data and the compressed color image data are managed separately. However, according to the preferred embodiment of the present invention, the compressed monochrome image data and the compressed color image data created from the same original document can be managed by one file. Moreover, by providing the monochrome image data definition area in the JPEG file, only the compressed monochrome image data can be specified from the JPEG file.

When it is apparent from the beginning that a printing process based on the compressed monochrome image data will not be carried out, in other words, when only the compressed color image data is requested simply for carrying out an image processing by a remote terminal device, such as a computer device, the compressed monochrome image data may not be stored into a file.

Meanwhile, when only the compressed monochrome image data is requested for the facsimile transmission or the like, a coupling process may not be carried out.

Referring to FIG. 4 again, the coupled image data created by the coupling unit 326 is stored in the first storage unit 328 of the storage device 327, which is the storage unit. The storage device 327 includes the first storage unit 328 and the second storage unit 329. The first storage unit 328 stores the coupled image data. The second storage unit 329 stores monochrome data. After the monochrome data stored in the second storage unit 329 is output, the monochrome data is preferably deleted from the second storage unit 329. Further, when the compressed monochrome image data or the monochrome image data is used directly for an output process, such as the facsimile transmission and the printing process, without storing the compressed monochrome image data or the monochrome image data, the compressed monochrome image data or the monochrome image data may be transmitted to the first output unit 336 or the second output unit 338.

When an output destination is the first output unit 336 or the second output unit 338, the extracting unit 330 extracts the compressed monochrome image data from the coupled image data stored in the first storage unit 328. Specifically, the extracting unit 330 extracts the compressed monochrome image data in accordance with the tag recorded in the monochrome image data definition area included in the APP1 area 74 of the coupled image data. Further, when receiving data that is not necessary to be extracted, for example, when receiving monochrome data, such as the compressed monochrome image data or the monochrome image data instead of the coupled image data, the extracting unit 330 may transmit the monochrome data directly to the first output unit 336 or the second output unit 338.

When outputting a color image from a color output unit 340, the coupled image data may be transmitted directly to an output image processing unit 332. Alternatively, the compressed monochrome image data may be extracted from the coupled image data, and only the compressed color image data may be transmitted to the output image processing unit 332.

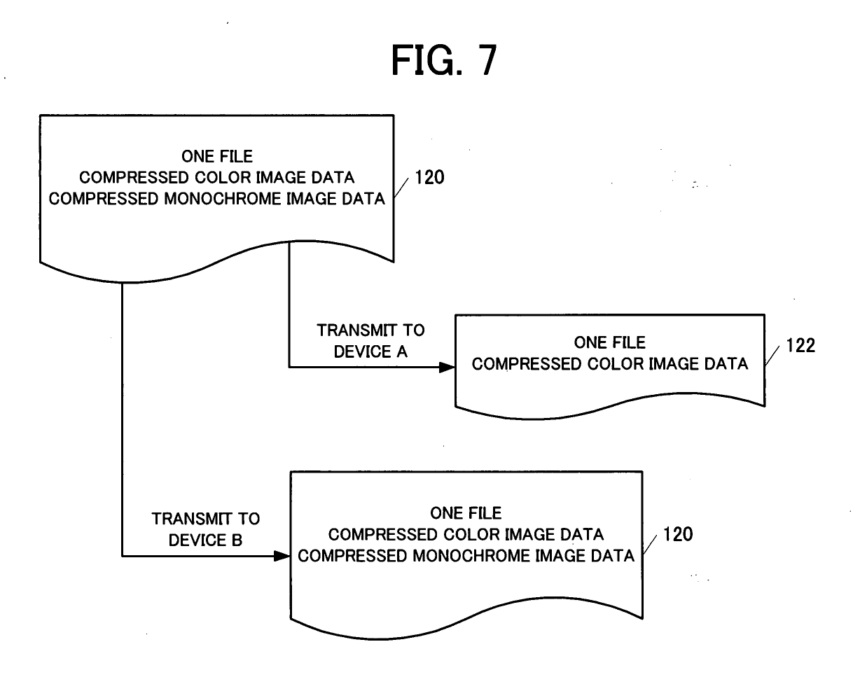

That is, as illustrated in FIG. 7, when a device of an output destination is a device A incapable of loading an APP1 area, the device A cannot retrieve the compressed monochrome image data included in coupled image data 120 of the second preferred embodiment of the present invention. Therefore, the extracting unit 330 previously extracts the compressed monochrome image data from the coupled image data and transmits only the compressed color image data to the output image processing unit 332. When a device of an output destination is a device B capable of loading an APP1 area, the coupled image data 120 is transmitted to the output image processing unit 332.

Further, the device A, which is an output destination of the coupled image data 120, cannot load the APP1 area. Therefore, when the coupled image data 120 is transmitted to the device A, the device A ignores the APP1 area. That is, the device A cannot recognize the contents of data of the APP1 area. Accordingly, when the device A receives the coupled image data 120, the device A handles the coupled image data 120 as a normal JPEG file, i.e., as multilevel color image data 122. As described above, in a device at the output destination that cannot load the APP1 area, a processing is carried out with the APP1 area ignored. Therefore, even when outputting to a device that cannot load the APP1 area, the compressed monochrome image data is not required to be extracted previously by the extracting unit 330.

However, from an aspect of reducing a size of transmission data, when a transmission destination is a device like the device A incapable of loading the APP1 area, it is preferable for the data to be transmitted to the output image processing unit 332 after the extracting unit 330 extracts the compressed monochrome image data or the monochrome image data unnecessary for data processing carried out by the transmission destination.

The output image processing unit 332 includes an output decompression unit 334. When data requested by an output destination is decompressed data instead of the compressed data, the output decompression unit 334 executes a decompression process on the compressed monochrome image data extracted by the extracting unit 330.

The control unit 342 controls the extracting process of the extracting unit 330 and the decompression process of the output decompression unit 334 to control a processing of the obtained image data.

Specifically, when a printing process is carried out as a monochrome output process based on the coupled image data stored in the first storage unit 328 or the compressed monochrome image data stored in the second storage unit 329, the output image processing unit 332 is controlled such that the decompression process is executed on the compressed monochrome image data from the extracting unit 330 by the output decompression unit 334 and the obtained monochrome image data is output. Further, the monochrome image data may be data stored in the second storage unit 329. In this case, the decompression process of the compressed monochrome image data in the output decompression unit 334 becomes unnecessary.

When facsimile transmission is carried out as a monochrome output process, the output image processing unit 332 is controlled such that the compressed monochrome image data from the extracting unit 330 or the compressed monochrome image data stored in the second storage unit 329 is output.

Further, in either case, monochrome data, i.e., the compressed monochrome image data or the monochrome image data, is stored in the second storage unit 329. When an output process based on such monochrome data is carried out by the output image processing unit 332, the processed monochrome data may be deleted from the second storage unit 329. The coupled image data to be output and a processing method are specified by operating an input unit, such as a keyboard, a mouse and a touch screen (not illustrated).

The first output unit 336 and the second output unit 338 for carrying out a monochrome output process and the color output unit 340 for carrying out a color output process are connected to the output image processing unit 332.

The first output unit 336 executes a processing relating to facsimile transmission based on the compressed monochrome image data output from the output image processing unit 332. The second output unit 338 executes a printing process based on the monochrome image data output from the output image processing unit 332.

The color output unit 340 executes a processing relating to a color output process, such as transmission to another computer system, based on the compressed color image data output from the output image processing unit 332.

In this case, when the transmission destination is the device B (refer to FIG. 7) capable of loading the APP1 area, the color output unit 340 transmits the coupled image data 120 as transmission data to the device B. The device B extracts the compressed monochrome image data stored in the APP1 area and carries out a monochrome printing process or the like. The device B can also carry out an image processing based on the compressed color image data. For example, the device B can edit or output the color multilevel image data.

In FIG. 4, a remote terminal device 344 is provided as a second input unit different from the image input unit 310 for inputting color multilevel image data. The remote terminal device 344 is connected to the storage device 327 via a network or the like.

The remote terminal device 344 is a device capable of downloading or receiving color multilevel image data. For example, the remote terminal device 344 is a digital camera, a color facsimile transceiver or an electronic terminal device. The data input to the storage device 327 can be any image data if the data is appropriate to be transmitted and received over the network, for example, the compressed color image data described above.

In the image processing device illustrated in FIG. 4, the color multilevel image data scanned by the image input unit 310 is converted into the compressed color image data by the color data creating unit 350 and converted into monochrome data (the compressed monochrome image data or the monochrome image data) by the monochrome data creating unit 352. Then, among the monochrome data, the compressed monochrome image data is coupled with the compressed color image data by the coupling unit 326, and the coupled image data is obtained. The coupled image data is transmitted to and stored in the first storage unit 328 of the storage device 327. The compressed monochrome image data or the monochrome image data that was not coupled with the compressed color image data is transmitted to and stored in the second storage unit 329.

When a command relating to a processing of the stored coupled image data is input from an input unit (not illustrated), the extracting unit 330 extracts the compressed monochrome image data according to necessity. Then, the extracted compressed monochrome image data is transmitted to the output image processing unit 332.

The control unit 342 carries out a control operation so that a dual operation is carried out in the output image processing unit 332. In the dual operation, a first processing and a second processing are carried out simultaneously. Further, in the first processing, for the image data stored previously in the first storage unit 328, the compressed monochrome image data extracted by the extracting unit 330 is output from the first output unit 336. In the second processing, the output decompression unit 334 executes the decompression processing, according to necessity, on the monochrome data generated from the color multilevel image data input from the image input unit 310 to convert the monochrome data into monochrome image data, and the monochrome image data is output from the second output unit 338.

Further, in the second preferred embodiment, the facsimile transmission process is carried out based on the stored coupled image data, and the printing process is carried out based on the color multilevel image data input from the image input unit 310. However, the present invention is not limited to such an example. For example, a printing process may be carried out based on the stored coupled image data, and the facsimile transmission may be carried out based on the color multilevel image data input from the image input unit 310.

By providing the remote terminal device 344 as the image input unit, a color output process from the color output unit 340 based on the color multilevel image data (or the compressed color image data) from the remote terminal device 344, a monochrome output process from the first output unit 336 or the second output unit 338 based on the color multilevel image data from the image input unit 310, and a monochrome output process from the first output unit 336 or the second output unit 338 based on the coupled image data stored in the storage device 327, can be carried out simultaneously. Further, if the dual operation is carried out for just the two monochrome output processes, the remote terminal device 344 is an optional structure.

Although not illustrated in the drawing, the option unit 100 illustrated in FIG. 5 may be provided at an output end of the remote terminal device 344. The data transmitted from the remote terminal device 344 to the storage device 327 may be configured to be coupled image data including the compressed monochrome image data and the compressed color image data described above. The coupled image data may be stored in the first storage unit 328 of the storage device 327. The compressed monochrome image data or the monochrome image data, which has not been coupled, may be stored in the second storage device 329. In this case, by providing a third output unit for carrying out a monochrome output process, a monochrome output process for the coupled image data stored in the storage device 327, a monochrome output process for the coupled image data based on the color multilevel image data input from the image input unit 310, and a monochrome output process for the coupled image data from the remote terminal device 344 can be carried out simultaneously. As the monochrome output processes, for example, a first processing for carrying out facsimile transmission, a second processing for carrying out a printing process, and a third processing for carrying out facsimile transmission to a destination different from a destination of the first processing, can be carried out.

As described above, in the second preferred embodiment of the present invention, the first storage unit 328 stores image data having a specific data structure, i.e., the coupled image data formed by coupling the compressed color image data and the compressed monochrome image data obtained based on the compressed color image data. Therefore, when carrying out the monochrome output process, the compressed monochrome image data can be just extracted from the coupled image data. As a result, without providing a device for carrying out the monochrome conversion process or the binarization process, the dual operation can be carried out.

A description will be made of specific examples of the dual operation. A description will be made of a dual operation processing (1) and a dual operation processing (2). The dual operation processing (1) is a processing in which a processing A and a processing B are carried out simultaneously. The dual operation processing (2) is a processing in which a processing C and a processing D are carried out simultaneously. Further, in the processing A, after an input image is stored temporarily, the input image is transmitted by facsimile as monochrome data. In the processing B, a previously stored image is retrieved, and the retrieved image is printed out as monochrome data. In the processing C, after an input image is stored temporarily, the input image is printed out as monochrome data. In the processing D, a previously stored image is retrieved, and the retrieved image is transmitted by facsimile as monochrome data.

(Processing A) Monochrome image data is generated from color multilevel image data input from the image input unit 310. A compressing process is executed on the monochrome image data, and compressed monochrome image data is generated. The generated compressed monochrome image data is stored temporarily in the second storage unit 329. Next, the compressed monochrome image data retrieved from the second storage unit 329 is output, i.e., transmitted by facsimile, from the first output unit 336. Further, after the compressed monochrome image data is retrieved from the second storage unit 329, the compressed monochrome image data is deleted from the second storage unit 329. That is, at normal facsimile transmission, after the facsimile transmission is completed, the compressed monochrome image data of the second storage unit 329 is deleted, and the second storage unit 329 becomes capable of overwriting. For one color multilevel image data, the facsimile transmission and the generation and the storage of the coupled image data can be carried out simultaneously. In this case, after the coupled image data is generated and stored in the first storage unit 328, compressed monochrome image data is extracted from the coupled image data and the extracted compressed monochrome image data is output from the first output unit 336. The coupled image data stored in the first storage unit 328 remains without being deleted even after the facsimile transmission.

(Processing B) Compressed monochrome image data is extracted from coupled image data stored previously in the first storage unit 328. The output decompression unit 334 executes a decompression processing on the extracted compressed monochrome image data, and monochrome image data is generated. Then, the monochrome image data is output, i.e., printed out, from the second output unit 338.

(Processing C) Monochrome image data is generated from color multilevel image data input from the image input unit 310. A compressing process is executed on the monochrome image data, and compressed monochrome image data is generated. Then, the compressed monochrome image data is stored temporarily in the second storage unit 329. Next, the output decompression unit 334 executes a decompression process of the compressed monochrome image data retrieved from the second storage unit 329, and monochrome image data is generated. Then, the monochrome image data is output, i.e., printed out, from the second output unit 338.

(Processing D) Compressed monochrome image data is extracted from coupled image data stored previously in the first storage unit 328. The extracted compressed monochrome image data is output, i.e., transmitted by facsimile, from the first output unit 336.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. An image processing device, comprising:
a document scanning unit which scans an original document;
a color image processing unit which converts scanned data obtained by the document scanning unit into color image data;
a monochrome image processing unit which converts the scanned data obtained by the document scanning unit into monochrome image data; and
a memory which stores both the color image data and the monochrome image data;
wherein a processing by the color image processing unit and a processing by the monochrome image processing unit are carried out simultaneously.

2. The image processing device according to claim 1, wherein the document scanning unit outputs data of Red, Green and Blue (RGB) color space as the scanned data; and
the monochrome image processing unit extracts data of a G component from the RGB color space and creates monochrome image data by using the data of the G component.

3. The image processing device according to claim 1, wherein the document scanning unit outputs data of Red, Green and Blue (RGB) color space as the scanned data;
the color image processing unit converts the data of the RGB color space into data of one of a luminance component and a lightness component, and data of one of a color difference and a chromaticity component; and
the monochrome image processing unit generates monochrome image data by using the data of one of the luminance component and the lightness component.

4. The image processing device according to claim 1, wherein the color image processing unit lowers a resolution of one of the color image data and the monochrome image data and generates low resolution image data, and the generated low resolution image data is associated with corresponding color image data or corresponding monochrome image data and stored into the memory.

5. The image processing device according to claim 1, further comprising:
a transmission unit which transmits one of the color image data and the monochrome image data stored in the memory to a remote device;
a transmission method table which associates the remote device of a destination with a transmission method to the destination;
a destination accepting unit which accepts a designation of the remote device of the destination; and
a transmission image retrieving unit which references the transmission method table and decides the transmission method for the destination accepted by the destination accepting unit, and retrieves one of the color image data and the monochrome image data associated with the decided transmission method from the memory and transmits to the transmission unit.

6. The image processing device according to claim 1, further comprising an image forming unit which carries out an image forming process of at least one of the color image data and the monochrome image data stored in the memory.

7. The image processing device according to claim 1, further comprising:
an output form accepting unit which accepts a designation of an output form of one of the color image data and the monochrome image data stored in the memory; and
a processing image data retrieving unit which retrieves one of the color image data and the monochrome image data corresponding to the output form accepted by the output form accepting unit from the memory.

8. An image processing device, comprising:
a first input unit which inputs color multilevel image data;
a color data compressing unit which carries out a compressing process of the color multilevel image data input from the first input unit and generates compressed color image data;
a monochrome conversion unit which converts the color multilevel image data input from the first input unit into monochrome image data;
a monochrome data compressing unit which carries out a compressing process of the monochrome image data generated by the monochrome conversion unit and generates compressed monochrome image data;
a coupling unit which couples the compressed color image data and the compressed monochrome image data generated from the same color multilevel image data and generates coupled image data;
a first storage unit which stores the coupled image data generated by the coupling unit;
a second storage unit which temporarily stores the monochrome data generated by the monochrome conversion unit;
an extracting unit which extracts compressed monochrome image data from the coupled image data retrieved from the first storage unit;
a first monochrome output unit which outputs one of the compressed monochrome image data and the monochrome image data;
a second monochrome output unit which outputs one of the compressed monochrome image data and the monochrome image data; and
a control unit which controls to simultaneously carry out a first processing and a second processing, wherein in the first processing, for the coupled image data previously stored in the first storage unit, the monochrome data extracted by the extracting unit is output from the first monochrome output unit, and in the second processing, the monochrome data generated from the color multilevel image data input from the first input unit is output from the second monochrome output unit.

9. The image processing device according to claim 8, wherein the monochrome conversion unit includes:
a monochrome conversion processing unit which generates monochrome multilevel image data from the color multilevel image data; and
a binarization unit which binarizes the generated monochrome multilevel image data and generates monochrome image data;
wherein the monochrome data compressing unit executes a compressing process of the monochrome image data, which is binary data, and generates compressed monochrome image data.

10. The image processing device according to claim 8, wherein the coupling unit couples the compressed color image data and the compressed monochrome image data in a same file and generates the coupled image data.

11. The image processing device according to claim 8, wherein the coupled image data includes a header area and an image data area, the compressed color image data is stored in the image data area, and the monochrome image data is stored in the header area.

12. The image processing device according to claim 11, wherein a monochrome image data definition area is provided in the header area of the coupled image data and stores a tag indicating a storage location and a size of the stored compressed monochrome image data.

13. The image processing device according to claim 12, wherein the extracting unit extracts the compressed monochrome image data in accordance with the tag stored in the monochrome image data definition area.

14. The image processing device according to claim 8, wherein the coupled image data has a Joint Photographic Experts Group (JPEG) compressed data format structure and includes:
a Start Of Image (SOI) area which stores starting information indicating a start of an image;
a monochrome storage area which stores the compressed monochrome image data;
a color storage area which stores the compressed color image data;
and an End Of Image (EOI) area which stores ending information indicating an end of the image.

15. An image processing device, comprising:
a multilevel decompression unit which executes a decompression process of compressed color image data input from a remote device;
a monochrome conversion unit which converts color multilevel image data obtained by the multilevel decompression unit into monochrome image data;
a monochrome data compression unit which executes a compressing process of the monochrome image data generated by the monochrome conversion unit and generates compressed monochrome image data; and
a coupling unit which couples the compressed color image data and the compressed monochrome image data generated from the same color multilevel image data and generates coupled image data.

16. The image processing device according to claim 15, wherein the monochrome conversion unit includes:
a monochrome conversion processing unit which generates monochrome multilevel image data from the color multilevel image data; and
a binarization unit which binarizes the generated monochrome multilevel image data and generates monochrome image data;
wherein the monochrome data compressing unit executes a compressing process of the monochrome image data, which is binary data, and generates the compressed monochrome image data.

17. The image processing device according to claim 15, wherein the coupling unit couples the compressed color image data and the compressed monochrome image data in a same file and generates coupled image data.

18. The image processing device according to claim 15, wherein the coupled image data includes a header area and an image data area, the compressed color image data is stored in the image data area, and the compressed monochrome image data is stored in the header area.

19. The image processing device according to claim 18, wherein a monochrome image data definition area is provided in the header area of the coupled image data and stores a tag indicating a storage location and a size of the stored compressed monochrome image data.

20. The image processing device according to claim 19, wherein the extracting unit extracts the compressed monochrome image data in accordance with the tag stored in the monochrome image data definition area.

21. The image processing device according to claim 15, wherein the coupled image data has a Joint Photographic Experts Group (JPEG) compressed data format structure including:
a Start Of Image (SOI) area which stores starting information indicating a start of an image;
a monochrome storage area which stores the compressed monochrome image data;
a color storage area which stores the compressed color image data; and
an End Of Image (EOI) area which stores ending information indicating an end of the image.

22. A data structure embodied in a computer-readable medium and executable by a processor, comprising:
a Joint Photographic Experts Group (JPEG) compressed data format structure generated from color multilevel image data input to an image processing device;
a Start Of Image (SOI) area which stores starting information indicating a start of an image;
an application segment area where an application segment is inserted;
a compressed image data storage unit which stores compressed image data; and
an End Of Image (EOI) area which stores ending information indicating an end of the image;
wherein the compressed image data storage area stores compressed color image data generated from the color multilevel image data, and the application segment area stores the compressed monochrome image data generated from the color multilevel image data.

23. The data structure according to claim 22, wherein the compressed monochrome image data is formed by compressing monochrome binary image data.

24. The data structure according to claim 22, wherein a monochrome image data definition area is provided in the application segment area and stores a tag indicating a storage location and a size of the stored compressed monochrome image data.
